(19) United States
(12) Patent Application Publication
(10) Pub. No.: US 2006/0252001 A1
(43) Pub. Date: Nov. 9, 2006

(54) Method and apparatus for positioning an orthodontic appliance

(76) Inventor: Eugene L. Dellinger, Fort Wayne, IN (US)

Correspondence Address: BAKER & DANIELS LLP;111 E. WAYNE STREET, SUITE 800, FORT WAYNE, IN, 46802, US

(21) Appl. No.: 11/122,946

(22) Filed: May 5, 2005

(51) Int. Cl. A61C 3/00

(52) U.S. Cl. 433/3

(57) ABSTRACT

A method and apparatus for delivering an orthodontic appliance is provided wherein pairs of mutually attracted members are applied to adjacent teeth in a mouth. The pairs of mutually attracted members are delivered via a thin strip of material and applied to adjacent teeth. The mutually attracted members facilitate retaining the adjacent teeth in a fixed, nonremovable relative position by the attractive force of the mutually attracted members. The orthodontic appliance allows the flossing of teeth unencumbered by wires or other orthodontic appliances.

### BACKGROUND

1. Field of the Invention

The present invention relates to orthodontics, and, more particularly, to a method and apparatus for delivering pairs of mutually attracted modules or members for application to adjacent teeth to retain the teeth in a desired position.

2. Description of the Prior Art

Prior to the present invention, many types of orthodontic appliances incorporating a variety of arrangements of mutually attracted elements, such as magnets, have been proposed. Some prior arrangements use magnets as a retaining device to retain teeth in a corrected position as a secondary function to primary tooth movement. Magnetic elements have also been used in combination with dentures for retaining the dentures in the mouth. When magnets are used as retaining devices, the magnets are placed onto teeth and the attractive force between the magnets provides a retaining force, thereby preventing the adjacent teeth from moving apart.

Other arrangements use magnets as corrective devices to move teeth into a corrected position. The conventional way for moving teeth in the mouth usually involves orthodontic appliances, such as braces and wires that exert a constant force on the tooth that needs to be moved. An elastic member creating the constant force must periodically be adjusted by a dentist or orthodontist. Many times dental appliances, including a retainer wire, are required across the front of the teeth to prevent excessive movement of the teeth.

Depending upon the application, wire braces or other types of removable orthodontic appliances are necessary. Magnets may be utilized in a number of ways in cooperation with such orthodontic appliances, such as by directly bonding magnets to the teeth, by means of attaching magnets to retainer wires, or by means of embedding magnets in the orthodontic appliance. One disadvantage of directly bonding magnets to the teeth is that it is difficult to obtain the necessary precision with conventional orthodontic tools, such as forceps, used to deliver the magnets to the teeth.

### SUMMARY

In general, a method and apparatus for delivering an orthodontic appliance is provided wherein pairs of mutually attracted members are applied to adjacent teeth in a mouth. The pairs of mutually attracted members are delivered via a thin strip of material and applied to adjacent teeth. The mutually attracted members facilitate retaining the adjacent teeth in constant relative position, as described above.

More specifically, a method and apparatus for delivering an orthodontic appliance is provided wherein pairs of mutually attracted members, e.g., magnets, are applied to adjacent teeth, thereby retaining the teeth in a desired position, for example, after the teeth have been moved to new positions by conventional orthodontic techniques. The magnets may be very small magnets which may be gold plated. Generally, the magnets are biocompatible. In one exemplary embodiment, the method of applying the magnets to the teeth includes placing two magnets on opposite sides of a thin, non-magnetic strip of material, such as Mylar™ material. Because the magnets are attracted to each other, they will stay in place on opposite sides of the strip. An adhesive is applied to each magnet, and/or to the teeth to which the magnets will be secured. In one exemplary embodiment, primer material is applied to the adjacent teeth in the locations where the magnets are to be placed and the adhesive is applied to the magnets. The Mylar™ strip is then placed in the space between two adjacent teeth. The thin, non-magnetic strip is then drawn forward between the adjacent teeth until the adhesive material on the magnets touches the primer material on the adjacent teeth. This allows ideal positioning of the magnets as determined by their individual magnetic fields. An ultraviolet light source can be used to cure the adhesive, and retain each of the magnets in place on one of the two adjacent teeth. The Mylar™ strip is then removed by pulling it through the space between the adjacent teeth, thereby leaving behind the magnets secured to the adjacent teeth. The magnets will retain the adjacent teeth in their positions because of the magnetic attraction between the magnets.

In an alternative embodiment, the mutually attracted members may be encapsulated within capsules for delivery and attachment to adjacent teeth. The capsules facilitate delivery and bonding of the orthodontic retainer system to adjacent teeth in the mouth.

In one form thereof, the present invention provides, in combination, an orthodontic retainer and retainer delivery system, including a pair of dental modules; and a delivery member associated with the dental modules, the dental modules accurately coupled to opposite sides of the delivery member.

In another form thereof, the present invention provides, in combination, an orthodontic retainer and retainer delivery system, the retainer for retaining the position of a pair of adjacent teeth, including a pair of dental modules; and a delivery member associated with the dental modules, the delivery member having a thickness sized to pass between the pair of adjacent teeth.

In yet another form thereof, the present invention provides a method of applying a pair of dental modules to a pair of adjacent teeth, including the steps of placing the pair of dental modules on opposite sides of a delivery member; placing the delivery member between the pair of adjacent teeth; pulling the delivery member between the pair of adjacent teeth until the pair of dental modules contacts the pair of adjacent teeth; securing the pair of dental modules, one each, to the pair of adjacent teeth; and removing the delivery member from between the pair of adjacent teeth.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of a delivery member of the present invention, further illustrating a coupled pair of mutually attracted members;

FIG. 2 is a top view of an individual's lower teeth, further illustrating the several steps of the method of the present invention;

FIG. 3 is a top view of a portion of an individual's lower teeth, further illustrating an alternative embodiment orthodontic retainer system according to the present invention;

FIG. 4 is a top view of a portion of an individual's lower teeth, further illustrating the orthodontic retainer system of FIG. 3;

FIG. 5 is a posterior view of the portion of an individual's lower teeth shown in FIG. 4; and

FIG. 6 is a perspective view of a capsule of the present invention, further illustrating a mutually attracted dental module encapsulated therein.

Corresponding reference characters indicate corresponding parts throughout the several views. Although the exemplifications set out herein illustrate the invention, the embodiments disclosed below are not intended to be exhaustive or to be construed as limiting the scope of the invention to the precise forms disclosed.

### DETAILED DESCRIPTION

The present invention generally provides a method and apparatus for delivering an orthodontic appliance. Pairs of mutually attracted members are coupled together and carried on a delivery member with scribe marks to indicate the depth of the delivery member with respect to the teeth. The delivery member is anteriorly pulled between a pair of adjacent teeth, whereby the pairs of mutually attracted members contact the adjacent teeth and are subsequently affixed to the pair of adjacent teeth via an adhesive. The delivery member is then pulled clear of the adjacent teeth, leaving behind the mutually attracted members affixed to the adjacent teeth. The mutually attracted members will retain the adjacent teeth in their positions because of the mutual attraction therebetween.

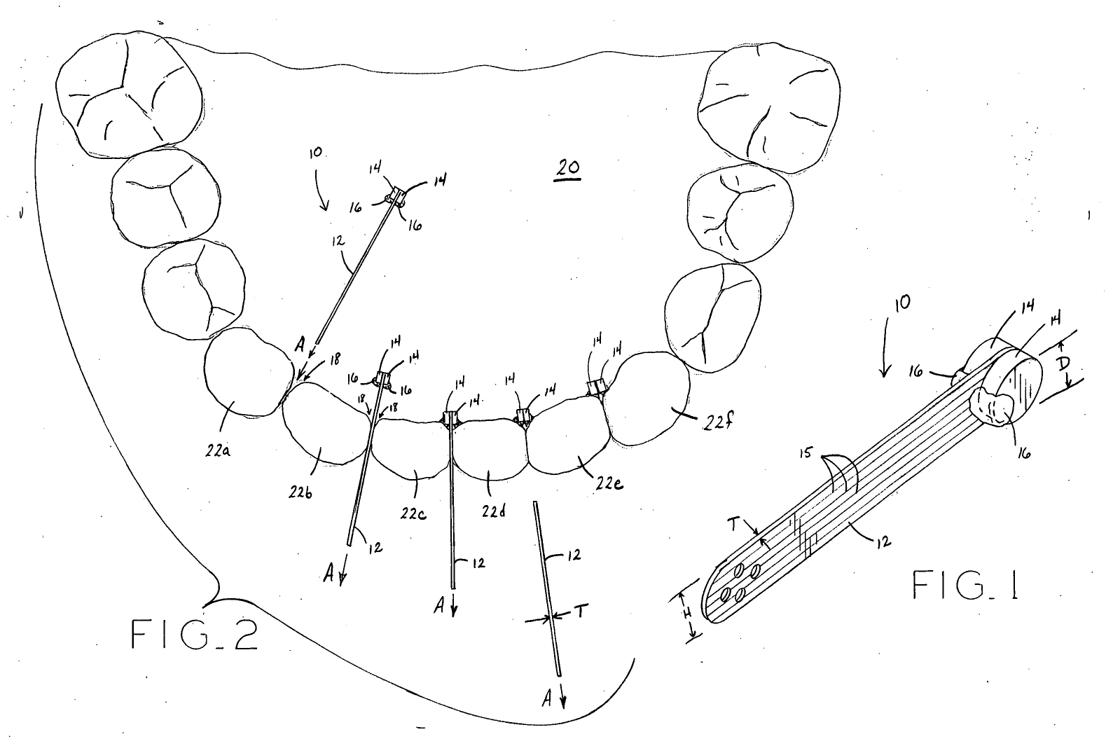

Referring now to FIG. 1, orthodontic retainer system 10 is shown, including strip or delivery member 12 and mutually attracted dental modules 14. Mutually attracted dental modules 14 are releasably coupled by attractive forces to opposite sides of delivery member 12. The phrase “mutually attracted dental modules,” for the purposes of this document, generally means two separate bodies which have a mutual attraction for each other and which are suitable for implantation in the mouth for a period of time. For example, in one embodiment, each mutually attracted dental module 14 may comprise a magnet or any other suitable device capable of mutual attraction, i.e., electrostatic members. When mutually attracted dental modules 14 are magnets, they are coupled together on delivery member 12 via magnetic forces. Each mutually attracted dental module 14 has a dimension D (FIG. 1), such as a height or a diameter, in the range of 0.010 to 0.040 inches, preferably in the range of 0.038 to 0.039 inches. In one form thereof, mutually attracted dental module 14 is in the shape of a cylinder, as shown in FIG. 1. Mutually attracted dental module 14 may also take different forms, including those having cross-sectional shapes such as various polygonal shapes. Each mutually attracted dental module 14 is made of a biocompatible material to allow its implantation in the mouth for a period of time. For example, each mutually attracted dental module 14 may be gold-plated, or, alternatively, could be comprised entirely of gold. In another embodiment, each mutually attracted dental module 14 comprises neodymium iron. As shown in FIG. 1, a quantity of adhesive 16 can be applied to an anterior face of each mutually attracted dental module 14 to facilitate securement of the same to a tooth.

Referring to FIGS. 1 and 2, delivery member 12 is a thin, non-magnetic strip of material, such as Mylar™ material, having a thickness T which, in one embodiment, may be between 0 and 0.010 inches, preferably between 0 and 0.005 inches, and more preferably, between 0 and 0.002 inches. Thickness T is such as to allow delivery member 12 to pass between a pair of adjacent teeth 22, for example, teeth 22a and 22b. The length of delivery member 12 can be any size to facilitate an easy access for an orthodontist for pulling delivery member 12 between a pair of adjacent teeth 22a and 22b, as will be described hereinbelow. Delivery member 12 may also include scribe marks 15 which may be lettered or numbered accordingly to provide a depth gauge, thereby providing the orthodontist with an indication of the depth of delivery member 12 with respect to adjacent teeth 22. In an alternative embodiment, delivery member 12 may be part of a continuous piece of material which has pairs of mutually attracted dental modules 14 carried thereon at various spaced distances. The orthodontist would then cut the continuous piece of material just beyond the location of mutually attracted dental modules 14 to obtain a single orthodontic retainer system 10. Height H of delivery member 12 may range from 0 to 10 millimeters, but height H may be increased depending on the desired application.

Referring now to FIG. 2, the method of applying magnetic orthodontic retainer system 10 will be described. Mouth 20 is shown including a plurality of teeth 22a-22f. In one embodiment, a pair of mutually attracted dental modules 14 are placed on opposite sides of delivery member 12, whereby the attractive coupling between mutually attracted dental modules 14 retains them in place on delivery member 12. Mutually attracted dental modules 14 are not bonded to delivery member 12, but, on the contrary, delivery member 12 functions to carry mutually attracted dental modules 14 to their final destination on adjacent teeth. A quantity of adhesive 16 is then placed on mutually attracted dental modules 14, or, alternatively, adhesive 16 may be applied to mutually attracted dental modules 14 prior to placing modules 14 on opposite sides of delivery member 12. Furthermore, primer material 18 is applied to a posterior surface of adjacent teeth 22, i.e., teeth 22b and 22c, in a location where the adhesive (16) applied to mutually attracted dental modules 14 will contact the surface of teeth 22b and 22c. Primer material 18 may comprise a material such as acid for etching a posterior surface of each tooth 22. Primer material 18 may also comprise chemical etching or any type of material to facilitate bonding with adhesive 16.

Referring still to FIG. 2, delivery member 12, with mutually attracted dental modules 14 carried thereon, is placed between a pair of adjacent teeth, for example, between teeth 22b and 22c. Delivery member 12 is then pulled in the general direction of Arrow A, as shown by delivery member 12 being pulled between teeth 22b and 22c. Arrow A generally indicates an anterior direction, i.e., towards the front of the mouth. Delivery member 12 is pulled until the pair of mutually attracted dental modules 14 contacts the teeth, as shown, for example, by mutually attracted dental modules 14 contacting teeth 22c and 22d. At this point, adhesive 16 contacts primer material 18. Adhesive 16 is then cured to harden adhesive 16 and attach mutually attracted dental modules 14 to teeth 22c and 22d. In one embodiment, an ultraviolet light source (not shown) may be used to cure adhesive 16.

To complete the operation, delivery member 12 is pulled further anteriorly to remove delivery member 12 from between any teeth, for example, as shown by delivery member 12 removed from between teeth 22d and 22e. Once delivery member 12 has been completely removed, mutually attracted dental modules 14 remain attached to teeth 22e and 22f, for example, to provide an orthodontic retainer system. Because mutually attracted dental modules 14 are not secured to delivery member 12 and are only carried thereon via the mutual attraction between mutually attracted dental modules 14, delivery member 12 simply slides between mutually attracted dental modules 14 and the adjacent teeth to which modules 14 are attached for removal of delivery member 12 from mouth 20. Movement of delivery member 12 after curing will not disturb dental modules 14 because the force coupling dental modules 14 to delivery member 12 is less than the force adhering dental modules 14 to the teeth. Once implanted, mutually attracted dental modules 14 retain adjacent teeth without the need for other, more cumbersome orthodontic appliances.

Although the above-described embodiments describe mutually attracted dental modules 14, the present invention also contemplates a method and apparatus for positioning mutually repelled dental modules 14′ (not shown). In this embodiment, mutually repelled dental modules 14′ could be positioned on adjacent teeth such that modules 14′ repel one another to move the adjacent teeth to a corrected position. Modules 14′ could be detachably adhered to delivery member 12 with a force less than the force adhering dental modules 14′ to the teeth. In one embodiment, modules 14′ may be magnets. If modules 14′ comprise magnets, the magnets would be oriented in a repelling, non-attractive position, for example, with the north pole of one module 14′ lined up with the north pole of the other module 14′. In contrast and as described above, mutually attracted dental modules 14 would be positioned such that, if modules 14 were magnets, the south pole of one module 14 would line up with the north pole of another module 14, such as to provide an attractive force between the two modules 14. Mutually repelled dental modules 14′ could be delivered and positioned on adjacent teeth in the mouth in a substantially identical manner as described above for modules 14.

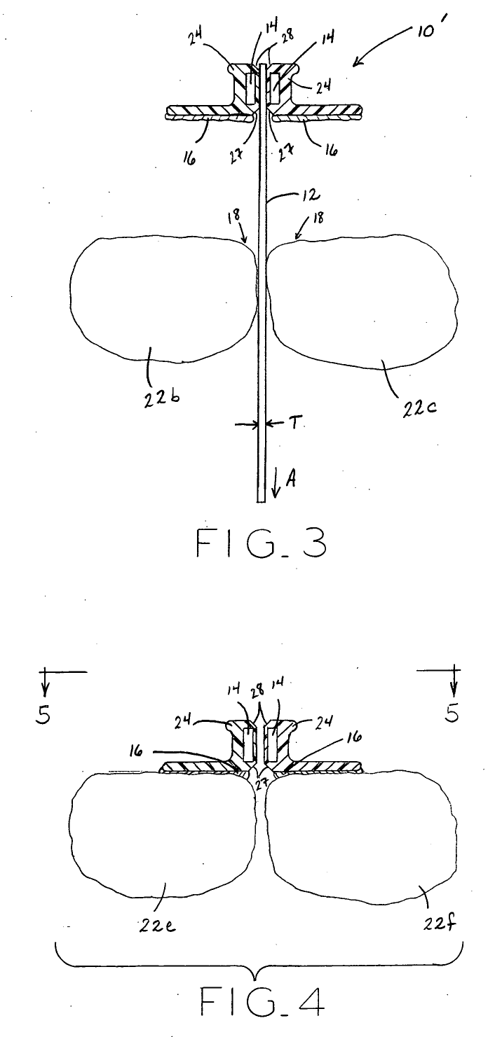

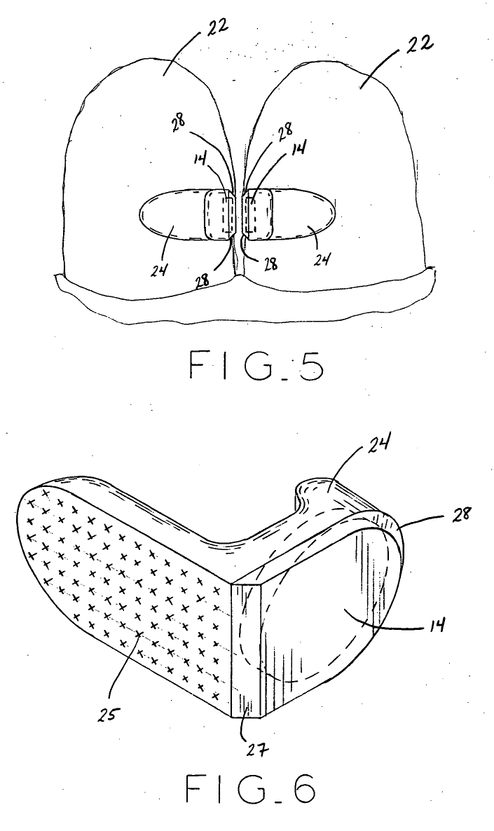

Referring now to FIG. 3, in an alternative embodiment, orthodontic retainer system 10′ is shown, including strip or delivery member 12 and mutually attracted dental modules 14 encapsulated within capsules 24. Capsules 24 may be formed of metal, ceramic, composite, or any other suitable biocompatible material. In an exemplary embodiment, capsule 24 should not include any sharp edges or irritating features such as features which possibly could cause harm to the tongue or other portions of the mouth. Referring now to FIG. 6, capsule 24 may include surface 25 which facilitates the application of adhesive 16 to capsule 24. Surface 25 may be a grid, mesh, or series of geometric undercuts in capsule 24 to provide an abrasive surface to which adhesive 16 is applied. Capsule 24 may include beveled edge 27 and beveled edge 28. Beveled edges 27 and 28 are provided to facilitate flossing of adjacent teeth 22 after capsules 24 are delivered. Beveled edges 27 and 28 are oriented such that a V-shaped groove is provided on both an upper portion and a lower portion of adjacent capsules 24, as shown in FIG. 5. Beveled edges 27 and 28 are also designed such that a V-shaped groove is provided on both an anterior portion and a posterior portion of adjacent capsules 24, as shown in FIG. 4.

Referring again to FIG. 3, mutually attracted dental modules 14 are used in a substantially identical way as described above wherein mutually attracted dental modules 14 are releasably coupled by attractive forces to opposite sides of delivery member 12.

The method of applying magnetic orthodontic retainer system 10′ is substantially identical to the method described above for applying magnetic orthodontic retainer system 10. Referring now to FIGS. 3 and 4, the mutual attraction of mutually attracted dental modules 14 retain both capsule 24 and module 14 in place on delivery member 12. Capsules 24 are not bonded to delivery member 12, but instead are held in place via the mutual attraction of mutually attracted dental modules 14 contained therein. A quantity of adhesive 16 is then placed on capsule 24 on surface 25, or, alternatively, adhesive 16 may be applied to capsule 24 prior to placing capsules 24 and modules 14 on opposite sides of delivery member 12. Furthermore, primer material 18 is applied to a posterior surface of adjacent teeth 22, i.e., teeth 22b and 22c, in a location where the adhesive (16) applied to capsules 24 will contact the surface of teeth 22b and 22c. Primer material 18 may comprise a material such as acid for etching a posterior surface of each tooth 22. Primer material 18 may also comprise chemical etching or any type of material to facilitate bonding with adhesive 16.

Similar to the method described above, delivery member 12, with mutually attracted dental modules 14 and capsules 24 carried thereon, is placed between a pair of adjacent teeth, for example, between teeth 22b and 22c. Delivery member 12 is then pulled in the general direction of Arrow A, as shown by delivery member 12 being pulled between teeth 22b and 22c. Delivery member 12 is pulled until the pair of capsules 24 contacts adjacent teeth. At this point, adhesive 16 contacts primer material 18. Adhesive 16 is then cured to harden adhesive 16 and attach capsules 24 to teeth 22. In one embodiment, an ultraviolet light source (not shown) may be used to cure adhesive 16.

To complete the operation, delivery member 12 is pulled further anteriorly to remove delivery member 12 from between any teeth, for example, as shown by delivery member 12 removed from between teeth 22e and 22f. Once delivery member 12 has been completely removed, capsules 24, with mutually attracted dental modules 14 retained therein, remain attached to teeth 22e and 22f, for example, to provide an orthodontic retainer. Because capsules 24 are not secured to delivery member 12 and are only carried thereon via the mutual attraction between mutually attracted dental modules 14, delivery member 12. simply slides between capsules 24 and the adjacent teeth to which capsules 24 are attached for removal of delivery member 12 from mouth 20. Movement of delivery member 12 after curing will not disturb capsules 24 because the force coupling capsules 24 to delivery member 12 is less than the force adhering capsules 24 to the teeth. Once implanted, mutually attracted dental modules 14 within capsules 24 retain adjacent teeth without the need for other, more cumbersome orthodontic appliances.

Orthodontic retainer system 10″ (not shown) may include capsules 24″ made of mutually attractive material. In one embodiment, capsules 24″ may be formed as a single entity with no separate mutually attracted dental module contained therein. Capsules 24 ″ could be formed through an injection molding process wherein the entire capsule 24″ would be formed into a mutually attracted dental body, for example, a magnet. In one embodiment, capsule 24″ may be entirely formed of magnetic material.

Although orthodontic retainer systems 10 and 10′ have only been shown as being applied to adjacent anterior teeth in the lower portion of the mouth, the systems may also be applied to any adjacent teeth located anywhere in the mouth. Furthermore, in an alternative embodiment (not shown), orthodontic retainer systems 10 and 10′ may be applied in any position on adjacent teeth as opposed to a lingual position as described hereinabove.

The method of application for orthodontic retainer systems 10 and 10′ described above may also be used in an alternative, indirect application. In an alternative embodiment, orthodontic retainer system 10 or 10′ is applied to an identical, non-human version of mouth 20, for example, a formed mold of mouth 20 including teeth 22. Orthodontic retainer system 10 or 10′ is applied to the formed mold of teeth 22 in an identical fashion as described above. After application to the mold, an orthodontist could use any indirect technique commonly known by the dental profession to simultaneously remove all capsules 24 and/or modules 14 and simultaneously apply all capsules 24 and/or modules 14 in the corresponding patient's mouth 20. All capsules 24 and/or modules 14 may be included in a delivery tray or elastic material having the capability to simultaneously move all capsules 24 and/or modules 14 from the mold to mouth 20.

While this invention has been described as having exemplary designs, the present invention may be further modified within the spirit and scope of this disclosure. This application is therefore intended to cover any variations, uses, or adaptations of the invention using its general principles.

1. In combination, an orthodontic retainer and retainer delivery system, comprising:
a pair of dental modules each comprising a magnet; and
a delivery member in the form of a single, substantially planar strip of material positioned between said pair of dental modules, said dental modules magnetically coupled to one another.

2-3. (canceled)

4. The combination of claim 1, wherein said delivery member comprises a non-magnetic strip of material.

5. The combination of claim 1, wherein said delivery member has a thickness less than 0.010 inches.

6. The combination of claim 5, wherein said delivery member has a thickness less than 0.005 inches.

7. The combination of claim 6, wherein said delivery member has a thickness less than 0.002 inches.

8. The combination of claim 1, wherein said delivery member includes a marking for gauging a depth of said delivery member.

9. The combination of claim 1, wherein said delivery member includes a plurality of markings for gauging a depth of said delivery member.

10. The combination of claim 1, further comprising a quantity of adhesive, said adhesive applied to an anterior face of each of said pair of dental modules.

11. The combination of claim 1, wherein each said dental module further comprises a capsule which at least partially encapsulates said magnet.

12. The combination of claim 11, wherein said capsule includes an abraded surface.

13. The combination of claim 12, further comprising a quantity of adhesive, said adhesive applied to said abraded surface of said capsule.

14. In combination, an orthodontic retainer and retainer delivery system, the retainer for retaining the position of a pair of adjacent teeth, comprising:
a pair of dental modules each comprising a magnet; and
a delivery member having a thickness sized to pass between the pair of adjacent teeth, said modules magnetically coupled together with said delivery member captured therebetween.

15. The combination of claim 14, wherein said delivery member thickness is less than 0.010 inches.

16. The combination of claim 15, wherein said delivery member thickness is less than 0.005 inches.

17. The combination of claim 16, wherein said delivery member thickness is less than 0.002 inches.

18. The combination of claim 14, wherein said delivery member includes a marking for gauging a depth of said delivery member.

19. The combination of claim 14, wherein said delivery member includes a plurality of markings for gauging a depth of said delivery member.

20. The combination of claim 14, wherein said pair of dental modules are releasably coupled to one another on opposite sides of said delivery member.

21-22. (canceled)

23. The combination of claim 14, wherein said delivery member comprises a non-magnetic strip of material.

24. The combination of claim 14, further comprising a quantity of adhesive, said adhesive applied to an anterior face of each of said pair of dental modules.

25. The combination of claim 14, wherein each said dental module further comprises a capsule which at least partially encapsulates said magnet.

26. The combination of claim 25, wherein said capsule includes an abraded surface.

27. The combination of claim 26, further comprising a quantity of adhesive, said adhesive applied to said abraded surface of said capsule.

28. A method of applying a pair of dental modules to a pair of adjacent teeth, each tooth having a lingual side and a labial side and each dental module including a magnet, comprising:
magnetically coupling the dental modules to one another on opposite sides of a delivery member with said delivery member captured therebetween;
placing said delivery member between the pair of adjacent teeth;
pulling said delivery member between the pair of adjacent teeth from the lingual side to the labial side of the teeth until the pair of dental modules contacts the pair of adjacent teeth on the lingual sides thereof;
securing the pair of dental modules, one each, to the pair of adjacent teeth; and
removing said delivery member by sliding said delivery member completely through a gap defined between the pair of adjacent teeth.

29. The method of claim 28, further comprising, prior to said step of securing the pair of dental modules, one each, to the pair of adjacent teeth, applying an adhesive to each member of the pair of dental modules.

30. The method of claim 29, further comprising, prior to said step of securing the pair of dental modules, one each, to the pair of adjacent teeth, applying a primer to the pair of adjacent teeth.

31. The method of claim 30, further comprising, subsequent to pulling said delivery member between the pair of adjacent teeth until the pair of dental modules contacts the pair of adjacent teeth, curing said adhesive.

32-33. (canceled)

34. The method of claim 28, further comprising, prior to said step of magnetically coupling the dental modules to one another on opposite sides of a delivery member, at least partially encapsulating the magnet of each module of the pair of dental modules within a capsule.

35. The method of claim 34, further comprising, prior to said step of securing the pair of dental modules, one each, to the pair of adjacent teeth, applying an adhesive to each said capsule.

36. The combination of claim 11, wherein each said capsule comprises biocompatible material.

37. The combination of claim 1, wherein said delivery member comprises a plastic strip of material.

38. The combination of claim 25, wherein each said capsule comprises biocompatible material.

39. The combination of claim 14, wherein said delivery member comprises a plastic strip of material.

40. The combination of claim 14, wherein said delivery member is a single, substantially planar strip of material.

41. The combination of claim 34, wherein each said capsule comprises biocompatible material.
